(19) United States
(12) Patent Application Publication
(10) Pub. No.: US 2025/0024256 A1
(43) Pub. Date: Jan. 16, 2025

(54) METHOD FOR AUTOMATICALLY AUTHENTICATING A RESIDENTIAL GATEWAY

(71) Applicant: SAGEMCOM BROADBAND SAS, Bois-Colombes (FR)

(72) Inventor: Nicolas KORBER, Bois-Colombes (FR)

(73) Assignee: SAGEMCOM BROADBAND SAS, Bois-Colombes (FR)

(21) Appl. No.: 18/759,257

(22) Filed: Jun. 28, 2024

(30) Foreign Application Priority Data
Jul. 11, 2023 (FR) 2307445

(51) Int. Cl. H04W 12/06; H04W 88/16

(52) U.S. Cl. CPC H04W 12/06; H04W 88/16

(57) ABSTRACT

A residential gateway that includes a modem for connecting to a mobile network via which a broadband network is accessible and a broadband controller for connecting to the broadband network. The residential gateway activates a service when a first authentication and a second authentication are successfully implemented, including: an authentication, by the broadband controller, of the residential gateway with the broadband network; and an authentication, by the modem, of the residential gateway with the mobile network via a user plane of the mobile network.

### TECHNICAL FIELD

The present invention relates to a method for the multifactor automatic authentication of a residential gateway offering broadband access services via a fixed wireless access (FWA).

### PRIOR ART

Fixed wireless access (FWA) technologies enable network operators to provide ultra-fast broadband access without having to deploy cable or fibre network structures, relying on the latest-generation mobile network technologies (4G, 5G, etc). This makes it possible in particular to provide broadband access services in suburban and rural geographical areas where deploying optical fibre may present high complexity of deployment and maintenance.

Moreover, so as to reinforce security of access to services, using double authentication, also referred to as two-factor authentication (2FA), is now widespread. The service is made accessible to an end user after the latter has presented two distinct proofs of identity to an authentication mechanism.

It is desirable to provide a solution that makes it possible to reinforce remote authentication of residential gateways to offer the end user access to certain services (e.g. internet access) without however requiring interaction with the end user.

### DISCLOSURE OF THE INVENTION

A method is proposed here for activating a service by a residential gateway, the residential gateway implementing a fixed wireless access FWA technology and comprising electronic circuitry implementing a modem for connecting the residential gateway to a mobile network via which a broadband network is accessible and a broadband controller for connecting the residential gateway to the broadband network via the mobile network. The method comprises a prior authentication of the residential gateway with the mobile network via a control plane, so as to make a communication link operational between the residential gateway and the mobile network via a user plane of the mobile network by which the residential gateway communicates with the broadband network. The method furthermore comprises a first authentication and a second authentication including: an authentication, by the broadband controller, of the residential gateway with the broadband network; and an authentication, by the modem, of the residential gateway with the mobile network via the user plane of the mobile network once the communication link between the residential gateway and the mobile network has been made operational by said prior authentication of the residential gateway with the mobile network. And the residential gateway activates the service when the first authentication and the second authentication have been implemented successfully.

Thus the remote authentication of the residential gateway to offer an end user access to certain services (e.g. internet access) is reinforced, without however requiring interaction with the end user.

According to a particular embodiment, the broadband controller instructs the modem to trigger authentication of the residential gateway with the mobile network via the user plane of the mobile network.

According to a particular embodiment, the second authentication is triggered after the first authentication has been implemented successfully.

According to a particular embodiment, the service is a service of access to services of the broadband network.

According to a particular embodiment, the authentication, by the modem, of the residential gateway with the mobile network via the user plane of the mobile network includes a sending of a message of the SMS type by the residential gateway.

According to a particular embodiment, the SMS message contains, in the body of said SMS message, a predetermined character string associated with the residential gateway.

A computer program is also proposed, comprising program code instructions causing an implementation of the method disclosed above in any one of its embodiments, when said instructions are executed by a processor. An information storage medium is also proposed here, storing such program code instructions.

According to a particular embodiment, during the authentication, by the modem, of the residential gateway with the mobile network via the user plane of the mobile network, the mobile network delegates said authentication to the broadband network.

A residential gateway is also proposed here, implementing a fixed wireless access FWA technology and comprising electronic circuitry configured to implement a modem for connecting the residential gateway to a mobile network via which a broadband network is accessible and a broadband controller for connecting the residential gateway to the broadband network via the mobile network. The electronic circuitry is configured to implement prior authentication of the residential gateway with the mobile network via a control plane, so as to make a communication link operational between the residential gateway and the mobile network via a user plane of the mobile network by which the residential gateway communicates with the broadband network. The electronic circuitry is furthermore configured to implement a first authentication and a second authentication including: an authentication, by the broadband controller, of the residential gateway with the broadband network; and an authentication, by the modem, of the residential gateway with the mobile network via the user plane of the mobile network, once the communication link between the residential gateway and the mobile network has been made operational by said prior authentication of the residential gateway with the mobile network. And the electronic circuitry is configured to activate the service when the first authentication and the second authentication have been implemented successfully.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a communication system;

FIG. 2 illustrates schematically an internal interconnection of a residential gateway of the communication system;

FIG. 3 illustrates schematically a hardware arrangement that can be used in the residential gateway;

FIG. 4 illustrates schematically logic communication pathways in the communication system;

FIG. 5 illustrates schematically an authentication algorithm implemented by the residential gateway, in one embodiment;

FIG. 6 illustrates schematically exchanges occurring in the communication system in the context of an authentication of the residential gateway, in one embodiment; and

FIG. 7 illustrates schematically exchanges occurring in the communication system in the context of an authentication of the residential gateway, in another embodiment.

### DETAILED DISCLOSURE OF EMBODIMENTS

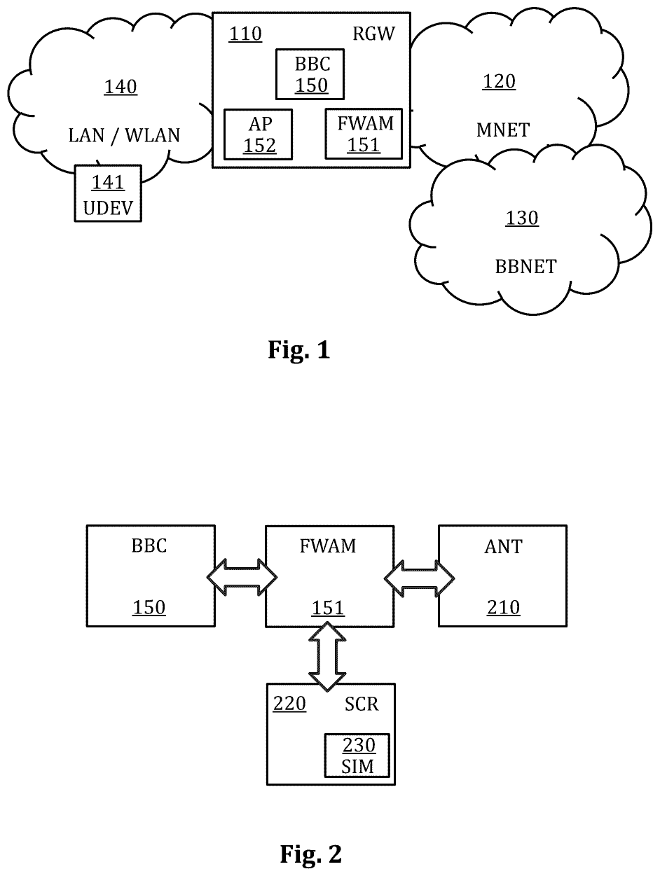

FIG. 1 illustrates schematically a communication system comprising a residential gateway RGW 110.

The residential gateway RGW 110 implements a fixed wireless access (FWA) technology. The residential gateway RGW 110 is considered to be equipment of the CPE (“Customer-Premises Equipment”) type in FWA technologies.

The residential gateway GW 110 is able to provide a set of services to an end user, including a service of access to a broadband network, also referred to as high-speed network or fixed-access network, BBNET 130 by means of a mobile network MNET 120. The terms “broadband network”, “high-speed network” and “fixed-access network” are used equivalently.

The residential gateway RGW 110 comprises a modem FWAM 151 for connecting the residential gateway RGW 110 to the mobile network MNET 120 and a broadband controller BBC 150 (or broadband-access controller) for connecting the residential gateway RGW 110 to the broadband network BBNET 130. The term “broadband controller” also means a controller of access to the broadband network, or equivalently a controller of access to the high-speed network.

The residential gateway GW 110 preferentially comprises a LAN (“Local Area Network”) interface manager, such as an access point AP 152 for establishing a network of the WLAN (“Wireless LAN”) type, such as for example a Wi-Fi network. The user can thus benefit from the services offered by the broadband network BBNET 130 by means of a terminal or user device UDEV 141 (such as a computer, an electronic tablet, a smartphone, a TV set-top box etc).

FIG. 2 illustrates schematically an internal interconnection of the residential gateway RGW 110.

The modem FWAM 151 is interconnected with the controller BBC 150.

The modem FWAM 151 is interconnected with a SIM (“Subscriber Identity Module”) card reader SCR 220 in which a SIM card 230 can be placed. In a variant, the modem FWAM 151 can be interconnected with a chip of the eSIM type soldered to an electronic card of the residential gateway RGW 110 or integrated by software and/or hardware in the residential gateway RGW 110. The modem FWAM 151 implements a user equipment UE function with respect to the mobile network MNET 120, in accordance with the technology employed in the mobile telephony network standards.

The modem FWAM 151 is interconnected with an antenna system ANT 210 enabling the modem FWAM 151 to communicate with equipment of the mobile network MNET 120.

The interconnections in the residential gateway RGW 110 can be made by means of communication buses, for example of the PCI (“Peripheral Component Interconnect”) or USB (“Universal Serial Bus”) type

To enable the residential gateway RGW 110 to benefit from the services of the mobile network MNET 120, the modem FWAM 151 implements an authentication of the SIM card 230, or of the eSIM chip, with the mobile network MNET 120, for example by exchanging with an authentication centre AuC of the mobile network MNET 120.

Following this prior authentication of the SIM card 230, or the chip eSIM, the modem FWAM 151 holds an encryption key enabling communications to be made by and with the residential gateway RGW 110 in the mobile network MNET 120. The residential gateway RGW 110 can thus benefit from the services of the mobile network MNET 120. An operational communication link is then established between the residential gateway RGW 110 and the core of the mobile network MNET 120, and other authentications can then be implemented to enable the residential gateway RGW 110 to benefit from the services of the broadband network BBNET 130.

The modem FWAM 151 and the controller BBC 150 operate independently of each other. Each has its own processing/computing and memory resources. The modem FWAM 151 and the controller BBC 150 can be implemented by software on one and the same processor and be interconnected by a software bus. The modem FWAM 151 and the controller BBC 150 can in a variant be implemented on separate processors and be interconnected by a hardware bus.

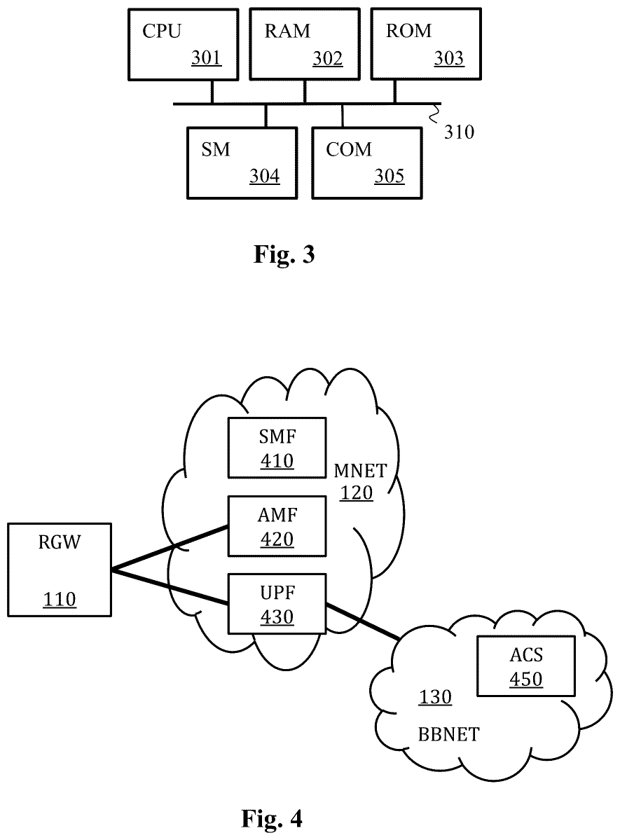

FIG. 3 illustrates schematically a hardware arrangement that can be used in the residential gateway RGW 110, more particularly for implementing the controller BBC 150 and/or the modem FWAM 151.

The hardware arrangement presented comprises, connected by a communication bus 310: a processor or CPU (“central processing unit”) 301; a random access memory (RAM) 302; a non-volatile memory, for example of the ROM (read only memory) 303 or EEPROM (“electrically-erasable programmable read-only memory”) type, or of the flash type; a storage unit, such as a storage medium SM 304, for example a hard disk HDD, or a storage medium reader, such as an SD (Secure Digital) card reader; and an interface manager COM 305.

The interface manager COM 305 enables the hardware arrangement presented to interact with other elements of the residential gateway RGW 110, such as for example the SIM card reader SCR 220 or the antenna system ANT 210 or the access point AP 152.

The processor or CPU 301 is capable of executing instructions loaded in the random access memory 302, in particular from the non-volatile memory 303 or from the storage medium SM (such as an SD card) 304. When the hardware arrangement presented is powered up, the processor or CPU 301 is thus capable of reading instructions from the random access memory RAM 302 and executing them. These instructions form a computer program causing in particular the implementation, by the processor or CPU 301, of the steps and behaviours described here in relation to the modem FWAM 151 and with the controller BBC 150, or more generally of the residential gateway RGW 110.

All or some of the steps and behaviours described here can thus be implemented in software form by executing a set of instructions by a programmable machine, for example a processor of the DSP (“digital signal processor”) type, or a microcontroller, or be implemented in hardware form by a machine or a dedicated electronic component (chip) or a dedicated set of electronic components (chipset), for example an FPGA (field-programmable gate array) or ASIC (application-specific integrated circuit) component. In general terms, the modem FWAM 151, and the controller BBC 150 and more generally the residential gateway RGW 110, comprise electronic circuitry adapted and configured to implement the steps and behaviours described here.

FIG. 4 illustrates schematically logic communication pathways in the communication system.

By way of illustration, the mobile network MNET 120 conforms to the 5G mobile telephony standards.

The mobile network MNET 120 comprises, apart from a radio access network RAN part, a core network part that includes various items of equipment and/or functions including an SMF (“Session Management Function”) entity 410, an AMF (“Access and Mobility management Function”) entity 420 and a UPF (“User Plane Function”) entity 430.

As its name indicates, the UPF entity manages the user plane, also referred to as data plane, i.e. the transport of the user traffic. A user-plane link thus connects the residential gateway RGW 110 and the UPF entity 430. This user-plane link is supported by an interface typically denoted NG-u between the radio access network part and the core network part.

Thus, with regard to the residential gateway RGW 110, the exchanges made between the residential gateway RGW 110 and the broadband network BBNET 130 pass through the UPF entity 430 in the mobile network MNET 120. In other words, the exchanges via the mobile network MNET 120 that involve the controller BBC 150 pass through the user plane link with the UPF entity 430, including exchanges authenticating the residential gateway RGW 110 with an auto configuration server ACS 450 of the broadband network BBNET 130. To exchange with the auto configuration server ACS 450, the controller BBC 150 typically implements a daemon in accordance with the protocol TR-069 (“CPE WAN Management Protocol”, published by the Broadband Forum).

The user data exchanges that involve the modem FWAM 151, such as exchanges by SMS (“Short Message Service”) messages, pass through the user plane link with the UPF entity 430.

To enable the user plane links to be established in the mobile network MNET 120, the SMF entity 410 and the AMF entity 420 cooperate in implementing the control plane of the mobile network MNET 120. A control-plane link thus connects the residential gateway RGW 110 and the AMF entity 420. This control-plane link is supported by an interface typically denoted NG-c between the radio access network part and the core network part.

Thus, with regard to the residential gateway RGW 110, the signalling exchanges made between the residential gateway RGW 110 and the mobile network MNET 120 pass through the AMF entity 420 in the mobile network MNET 120. In other words, this control-plane link is reserved for the modem FWAM 151 in the residential gateway RGW 110 and is not accessible to the controller BBC 150.

It is clear from the above that the modem FWAM 151 does not interact with the broadband network BBNET 130 and the controller BBC 150 does not interact with the mobile network MNET 120. By way of illustrative example, this means that an IP (“Internet Protocol”) address for the controller BBC 150 is procured from a DHCP (“Dynamic Host Configuration Protocol”) server located in the broadband network BBNET 130, and an IP address for the modem FWAM 151 is for its part procured from the SMF entity 410 located in the mobile network MNET 120.

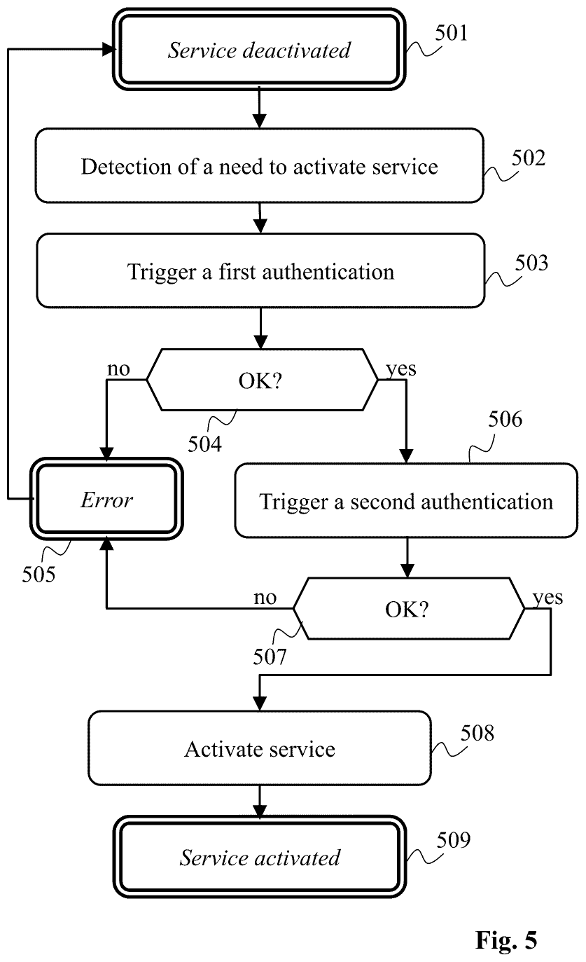

FIG. 5 illustrates schematically an authentication algorithm implemented by the residential gateway RGW 110, in one embodiment. The authentication algorithm enables the residential gateway RGW 110 to decide to activate, or not, a service. According to a preferred embodiment, the service is a service of access to services offered by the broadband network BBNET 130. More particularly, the service can be an establishment of a user-plane link between the controller BBC 150 and the broadband network BBNET 130. The service can also be the establishment of the local area network LAN or WLAN.

In a state 501, the service is deactivated. The communication link with the mobile network MNET 120 is operational, which means that the aforementioned prior authentication has been implemented. Thus the aforementioned user-plane and control-plane links have been established.

In a step 502, the residential gateway RGW 110 detects a need to activate the service. For example, the need to activate the service is detected when the residential gateway RGW 110 has ended an initialisation phase on start-up or after a restarting.

In a step 503, the residential gateway RGW 110 triggers a first authentication with the broadband network BBNET 130. The first authentication is for example an authentication based on certificates relying on an exchange protocol of the “handshake” type.

In a step 504, the residential gateway RGW 110 checks that the first authentication has been successful. If such is the case, a step 506 is performed; otherwise the residential gateway RGW 110 goes into an error state 505. For example, a light signal and/or audible signal is activated by the residential gateway RGW 110.

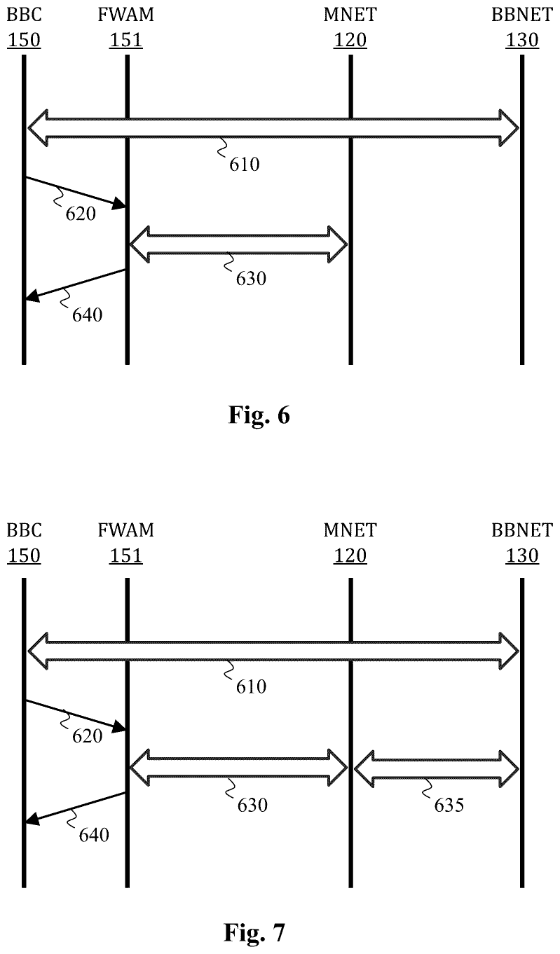

In the step 506, the residential gateway RGW 110 triggers a second authentication with the mobile network MNET 120. The second authentication is implemented via the user plane of the mobile network MNET 120 (i.e. the communication link between the residential gateway RGW 110 and the core-network part of the mobile network MNET 120 is operational). The second authentication is for example the transmission by the residential gateway RGW 110 of a predetermined character string associated with the residential gateway RGW 110, such as a secret known to the residential gateway RGW 110 and to the core-network part of the mobile network MNET 120 (see FIG. 6) or a secret known to the residential gateway RGW 110 and to the broadband network BBNET 130 (see FIG. 7).

It should be noted that the second authentication is different from the prior authentication previously mentioned, since said prior authentication makes it possible to make operational a communication link between the residential gateway RGW 110 and the mobile network MNET 120, whereas this communication link must be operational to be able to implement the second authentication.

In a step 507, the residential gateway RGW 110 checks that the second authentication has been successful. If such is the case, a step 508 is performed; otherwise the residential gateway RGW 110 goes into the error state 505. For example, a light signal and/or audible signal is activated by the residential gateway RGW 110.

In the step 508, the residential gateway RGW 110 activates the service, and goes into a state 509 where the service is activated. Thus the service has been able to be activated by a double authentication, automatically, without intervention by the user.

In a particular embodiment, the second authentication (with the mobile network MNET 120) is ordered to the modem FWAM 151 by the controller BBC 150.

The first authentication is presented above as being implemented with the broadband network BBNET 130 and the second authentication as being implemented with the mobile network MNET 120. In a variant, the first authentication is implemented with the mobile network MNET 120 and the second authentication is implemented with the broadband network BBNET 130. The first and second authentications can in a variant also be implemented in parallel.

In a particular embodiment, the first and second authentications have a lifespan, and must be reiterated once this lifespan has elapsed. To monitor this aspect, in the state 509, the controller BBC 150 triggers a time delay with a duration equal to the lifespan in question. When the time delay expires, the residential gateway RGW 110 goes into the state 501 again, and the first and second authentications must be renewed.

FIG. 6 illustrates schematically exchanges occurring in the communication system in the context of an authentication of the residential gateway RGW 110, in one embodiment.

FIG. 6 shows first-authentication exchanges 610 between the controller BBC 150 and an item of equipment of the broadband network BBNET 130 (see for example FIG. 5, in particular the step 503), typically the auto configuration server ACS 450. These exchanges pass through the user plane of the mobile network MNET 120 (communication link operational by virtue of the prior authentication).

When the first authentication has ended successfully, the controller BBC 150 sends an instruction 620 to the modem FWAM 151 to trigger the second authentication. Second-authentication exchanges 630 then take place between the modem FWA 151 and an item of equipment of the mobile network MNET 120 (see for example FIG. 5, in particular the step 506).

When the second authentication has ended successfully, the modem FWAM 151 sends corresponding information 640 to the controller BBC 150, which can then activate the service (see FIG. 5). If the second authentication ends in an authentication failure, the modem FWAM 151 informs the controller BBC 150 of this, which then decides not to activate the service (see FIG. 5).

FIG. 7 illustrates schematically exchanges occurring in the communication system in the context of an authentication of the residential gateway RGW 110, in another embodiment.

FIG. 7 also shows the first-authentication exchanges 610, as well as the sending of the instruction 620 to trigger the second authentication and the second-authentication exchanges 630.

FIG. 7 differs from FIG. 6 in that, in the context of second-authentication exchanges 630, the item of equipment of the mobile network MNET 120 makes exchanges with an item of equipment of the broadband network BBNET 130, typically the auto configuration server ACS 450. The equipment of the mobile network MNET 120 then serves only as an intermediary between the broadband network BBNET 130 and the modem FWA 151 (which is not configured to communicate with equipment of the broadband network BBNET 130), and thus delegates responsibility for the second authentication to the broadband network BBNET 130.

When the second authentication has ended successfully (here by decision of the item of equipment of the broadband network BBNET 130), the modem FWAM 151 sends corresponding information 640 to the controller BBC 150, which can then activate the service (see FIG. 5). If the second authentication ends in an authentication failure (here by decision of the item of equipment of the broadband network BBNET 130), the modem FWAM 151 informs the controller BBC 150 of this, which then decides not to activate the service (see FIG. 5).

In a particular embodiment, the modem FWAM 151 initiates the second authentication by formatting a dedicated SMS message intended for a dedicated telephone number. Preferentially, this SMS message contains, in the body of said SMS message, a predetermined character string associated with the residential gateway RGW 110, such as an identifier of the residential gateway RGW 110. Thus, in addition to the source telephone number of the SMS message (linked to the SIM card or to the eSIM chip), this SMS message can contain a serial number, or an IMEI (“International Mobile Equipment Identity”), or a unique key attributed to the residential gateway RGW 110. This SMS message is sent by the residential gateway RGW 110 without interaction with the user and, since this SMS message is not intended to be read by the user, the residential gateway deletes it without storing it in the SIM card or in memory of the modem FWAM 151. Service SMS message or silent SMS message is spoken of. The core-network part of the mobile network MNET 120, via an SMSC (“Short Message Service Centre”) messaging centre, receives this service SMS message and processes it, or exchanges with an item of equipment of the broadband network BBNET 130, to implement the second authentication.

1. A method for activating a service by a residential gateway, the residential gateway implementing a fixed wireless access FWA technology and comprising electronic circuitry implementing a modem for connecting the residential gateway to a mobile network via which a broadband network is accessible and a broadband controller for connecting the residential gateway to the broadband network via the mobile network,
the method comprises;
a prior authentication of the residential gateway with the mobile network via a control plane, so as to make a communication link operational between the residential gateway and the mobile network via a user plane of the mobile network by which the residential gateway communicates with the broadband network, a first authentication and a second authentication including:
an authentication, by the broadband controller, of the residential gateway with the broadband network; and
an authentication, by the modem, of the residential gateway with the mobile network via the user plane of the mobile network, once the communication link between the residential gateway and the mobile network has been made operational by said prior authentication of the residential gateway with the mobile network;
wherein the residential gateway activating the service when the first authentication and the second authentication have been implemented successfully.

2. The method according to claim 1, wherein the broadband controller instructs the modem to trigger the authentication of the residential gateway with the mobile network via the user plane of the mobile network.

3. The method according to claim 1, wherein the second authentication is triggered after the first authentication has been implemented successfully.

4. The method according to claim 1, wherein the service is a service of access to services of the broadband network.

5. The method according to claim 1, wherein the authentication, by the modem, of the residential gateway with the mobile network via the user plane of the mobile network, includes a sending of an SMS message by the residential gateway.

6. The method according to claim 5, wherein the SMS message contains, in the body of said SMS message, a predetermined character string associated with the residential gateway.

7. The method according to claim 1, wherein, during the authentication, by the modem, of the residential gateway with the mobile network via the user plane of the mobile network, the mobile network delegates said authentication to the broadband network.

8. A residential gateway implementing a fixed wireless access FWA technology and comprising electronic circuitry configured to implement a modem for connecting the residential gateway to a mobile network via which a broadband network is accessible and a broadband controller for connecting the residential gateway to the broadband network via the mobile network, the electronic circuitry being configured to implement:
a prior authentication of the residential gateway with the mobile network via a control plane, so as to make a communication link operational between the residential gateway and the mobile network via a user plane of the mobile network by which the residential gateway communicates with the broadband network, a first authentication and a second authentication including:
an authentication, by the broadband controller, of the residential gateway with the broadband network; and
an authentication, by the modem, of the residential gateway with the mobile network via the user plane of the mobile network, once the communication link between the residential gateway and the mobile network has been made operational by said prior authentication of the residential gateway with the mobile network,
wherein the electronic circuitry being configured to activate the service when the first authentication and the second authentication have been implemented successfully.

9. (canceled)

10. A non-transitory information storage medium storing program code instructions causing an implementation of the method according to claim 1, when said instructions are read and executed by a processor.
